(19) United States
(12) Patent Application Publication
(10) Pub. No.: US 2026/0149650 A1
(43) Pub. Date: May 28, 2026

(54) SYSTEM AND METHOD FOR AUTOMATICALLY ANALYZING AND CONSOLIDATING REAL-TIME AND HISTORICAL COMMUNICATIONS RECEIVED THROUGH SEPARATE TRANSMISSIONS IN A REMOTE ELECTRONIC ENVIRONMENT

(71) Applicant: BANK OF AMERICA CORPORATION, Charlotte, NC (US)

(72) Inventors: Ajay Menon, Tokyo (JP); Manu Kurian, Dallas, TX (US)

(73) Assignee: BANK OF AMERICA CORPORATION, Charlotte, NC (US)

(21) Appl. No.: 18/960,488

(22) Filed: Nov. 26, 2024

(51) Int. Cl. H04L 43/04; H04L 43/08; H04L 65/80

(52) U.S. Cl. CPC H04L 43/04; H04L 43/08; H04L 65/80

(57) ABSTRACT

Embodiments of the present invention provide a system for automatically analyzing and consolidating real-time and historical communications received through separate transmissions in a remote electronic environment. The system is configured for continuously monitoring one or more communications associated with an entity, continuously collecting data associated with the one or more communications, analyzing the collected data associated with the one or more communications, via a generative artificial intelligence engine, storing analysis associated with the collected data in a data repository, identifying a real-time communication associated with the entity, analyzing real-time data associated with the real-time communication, and consolidating the real-time data and at least a part of the collected data to generate a real-time dataset for the real-time communication.

### BACKGROUND

There exists a need for a system for automatically analyzing and consolidating real-time and historical communications received through separate transmissions in a remote electronic environment.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for automatically analyzing and consolidating real-time and historical communications received through separate transmissions in a remote electronic environment. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention continuously monitors one or more communications associated with an entity, continuously collects data associated with the one or more communications, analyzes the collected data associated with the one or more communications, via a generative artificial intelligence engine, stores analysis associated with the collected data in a data repository, identifies a real-time communication associated with the entity, analyzes real-time data associated with the real-time communication, and consolidates the real-time data and at least a part of the collected data to generate a real-time dataset for the real-time communication.

In some embodiments, analyzing the real-time data further comprises parsing through the analysis associated with collected data stored in the data repository to identify at least the part of the collected data that is associated with the real-time data.

In some embodiments, continuously collecting the data associated with the one or more communications further comprises at least one of transforming the collected data, rearranging the collected data, and storing the collected data in a data format that is compatible with the generative artificial intelligence engine.

In some embodiments, the present invention generates one or more summaries or one or more reports associated with the one or more communications and the real-time communication.

In some embodiments, the one or more communications and the real-time communication are transmitted over a plurality of separate transmissions.

In some embodiments, the one or more communications and the real-time communication are physical live conversations between users associated with the entity captured by an entity system associated with the entity.

In some embodiments, the one or more communications are between at least one of plurality of users, a plurality of user devices, a plurality of entity systems, and a plurality of other entity systems.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for automatically analyzing and consolidating real-time and historical communications received through separate transmissions in a remote electronic environment, in accordance with an embodiment of the invention;

FIG. 2 provides a block diagram illustrating the entity system 200 of FIG. 1, in accordance with an embodiment of the invention;

FIG. 3 provides a block diagram illustrating an electronic communication analysis and consolidation system 300 of FIG. 1, in accordance with an embodiment of the invention;

FIG. 4 provides a block diagram illustrating the computing device system 400 of FIG. 1, in accordance with an embodiment of the invention;

FIG. 5 illustrates an exemplary generative AI subsystem 500, in accordance with an embodiment of the invention; and

FIG. 6 provides a process flow for automatically analyzing and consolidating real-time and historical communications received through separate transmissions in a remote electronic environment, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that receives a plurality of electronic communications associated with one or more entity operations. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, potential customer, customer, and/or of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Issues often arise in remote electronic environment where communications occur between at least two users/user devices, and where past communications have occurred in separate communication transmission regarding the same or similar subject, but it is difficult for either users to recall what was said or decided on. Such an issue is exacerbated when many minutes and hours have occurred in previous communications, and there is too much data to sift through. As such, these exists a system for automatically analyzing and consolidating real-time and historical communications received through separate transmissions in a remote electronic environment. The system of this invention solves this problem as discussed in detail below.

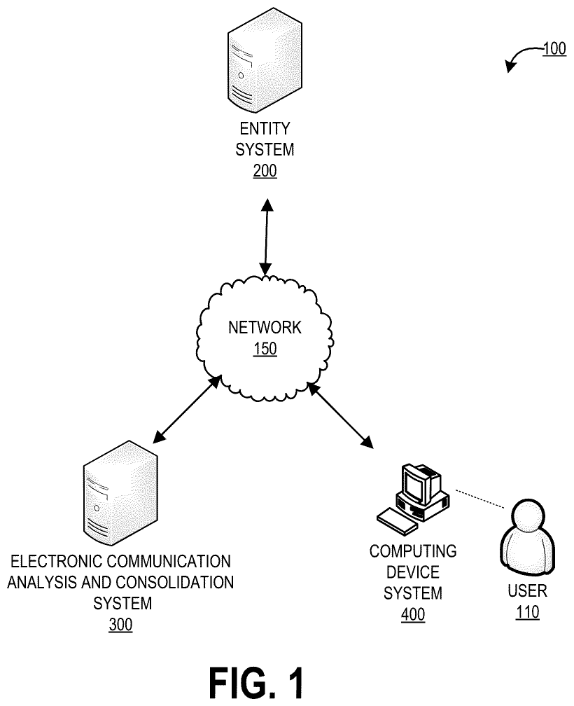

FIG. 1 provides a block diagram illustrating a system environment 100 for automatically analyzing and consolidating real-time and historical communications received through separate transmissions in a remote electronic environment, in accordance with an embodiment of the invention. As illustrated in FIG. 1, the environment 100 includes an electronic communication analysis and consolidation system 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200. In some embodiments, the one or more users 110 may be employees of the entity associated with the entity system 200.

The entity system(s) 200 may be any system owned or otherwise controlled by an entity to support or perform one or more process steps described herein. In some embodiments, the entity may be any organization that receives a plurality of electronic communications associated with one or more entity operations. In some embodiments, the entity is a financial institution. In some embodiments, the entity is a non-financial institution.

The electronic communication analysis and consolidation system 300 is a system of the present invention for performing one or more process steps described herein. In some embodiments, the electronic communication analysis and consolidation system 300 may be an independent system. In some embodiments, the electronic communication analysis and consolidation system 300 may be a part of the entity system 200. In some embodiments, the electronic communication analysis and consolidation system 300 may be controlled, owned, managed, and/or maintained by the entity associated with the entity system 200.

The electronic communication analysis and consolidation system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the electronic communication analysis and consolidation system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the electronic communication analysis and consolidation system 300, and/or entity system 200 across the network 150.

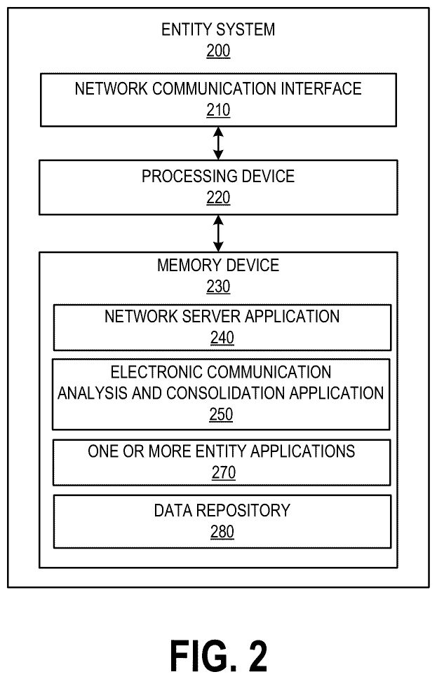

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an electronic communication analysis and consolidation application 250, one or more entity applications 270, and a data repository 280. The one or more entity applications 270 may be any applications developed, supported, maintained, utilized, and/or controlled by the entity. The computer-executable program code of the network server application 240, the electronic communication analysis and consolidation application 250, the one or more entity application 270 to perform certain logic, data-extraction, and data-storing functions of the entity system 200 described herein, as well as communication functions of the entity system 200.

The network server application 240, the electronic communication analysis and consolidation application 250, and the one or more entity applications 270 are configured to store data in the data repository 280 or to use the data stored in the data repository 280 when communicating through the network communication interface 210 with the electronic communication analysis and consolidation system 300, and/or the computing device system 400 to perform one or more process steps described herein. In some embodiments, the entity system 200 may receive instructions from the electronic communication analysis and consolidation system 300 via the electronic communication analysis and consolidation application 250 to perform certain operations. The electronic communication analysis and consolidation application 250 may be provided by the electronic communication analysis and consolidation system 300. The one or more entity applications 270 may be any of the applications used, created, modified, facilitated, developed, and/or managed by the entity system 200.

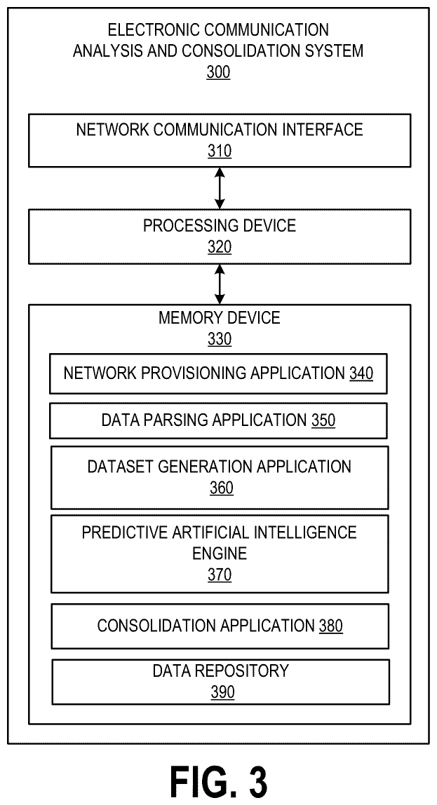

FIG. 3 provides a block diagram illustrating the electronic communication analysis and consolidation system 300 in greater detail, in accordance with embodiments of the invention. As illustrated in FIG. 3, in one embodiment of the invention, the electronic communication analysis and consolidation system 300 includes one or more processing devices 320 operatively coupled to a network communication interface 310 and a memory device 330. In certain embodiments, the electronic communication analysis and consolidation system 300 is operated by an entity, such as a financial institution. In some embodiments, the electronic communication analysis and consolidation system 300 is owned or operated by the entity of the entity system 200. In some embodiments, the electronic communication analysis and consolidation system 300 may be an independent system. In alternate embodiments, the electronic communication analysis and consolidation system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the electronic communication analysis and consolidation system 300. For example, in one embodiment of the electronic communication analysis and consolidation system 300, the memory device 330 includes, but is not limited to, a network provisioning application 340, a data parsing application 350, a dataset generation application 360, a predictive artificial intelligence engine 370, a consolidation application 380, and a data repository 390 comprising any data processed or accessed by one or more applications in the memory device 330. The computer-executable program code of the network provisioning application 340, the data parsing application 350, the dataset generation application 360, the predictive artificial intelligence engine 370, and the consolidation application 380 may instruct the processing device 320 to perform certain logic, data-processing, and data-storing functions of the electronic communication analysis and consolidation system 300 described herein, as well as communication functions of the electronic communication analysis and consolidation system 300.

The network provisioning application 340, the data parsing application 350, the dataset generation application 360, the predictive artificial intelligence engine 370, and the consolidation application 380 are configured to invoke or use the data in the data repository 390 when communicating through the network communication interface 310 with the entity system 200, and/or the computing device system 400. In some embodiments, the network provisioning application 340, the data parsing application 350, the dataset generation application 360, the predictive artificial intelligence engine 370, and the consolidation application 380 may store the data extracted or received from the entity system 200, and the computing device system 400 in the data repository 390. In some embodiments, the network provisioning application 340, the data parsing application 350, the dataset generation application 360, the predictive artificial intelligence engine 370, and the consolidation application 380 may be a part of a single application (e.g., modules).

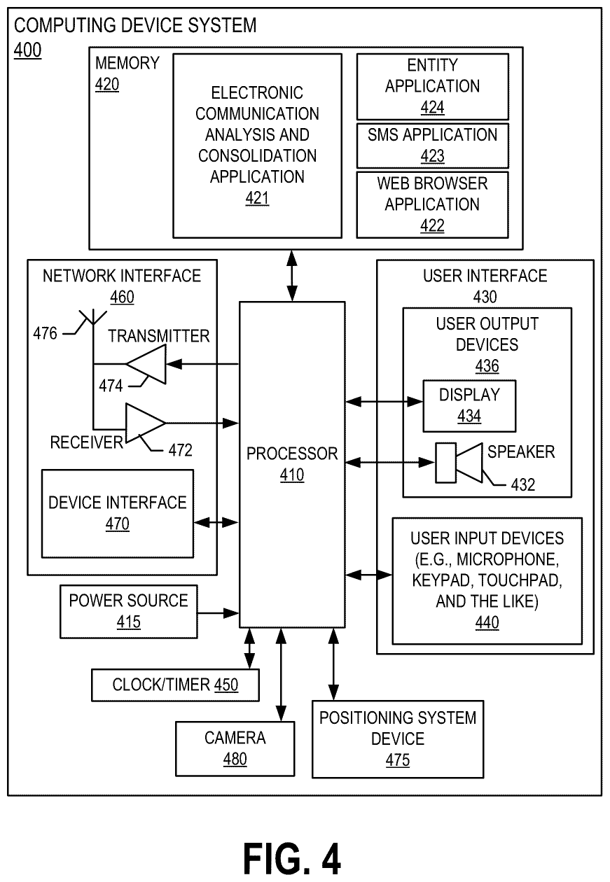

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an electronic communication analysis and consolidation application 421, entity application 424. These applications also typically instructions to a graphical user interface (GUI) on the display 430 that allows the user 110 to interact with the entity system 200, the electronic communication analysis and consolidation system 300, and/or other devices or systems. The memory 420 of the computing device system 400 may comprise a Short Message Service (SMS) application 423 configured to send, receive, and store data, information, communications, alerts, and the like via the network. In some embodiments, the electronic communication analysis and consolidation application 421 provided by the electronic communication analysis and consolidation system 300 allows the user 110 to access the electronic communication analysis and consolidation system 300. In some embodiments, the entity application 424 provided by the entity system 200 and the electronic communication analysis and consolidation application 421 allow the user 110 to access the functionalities provided by the electronic communication analysis and consolidation system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

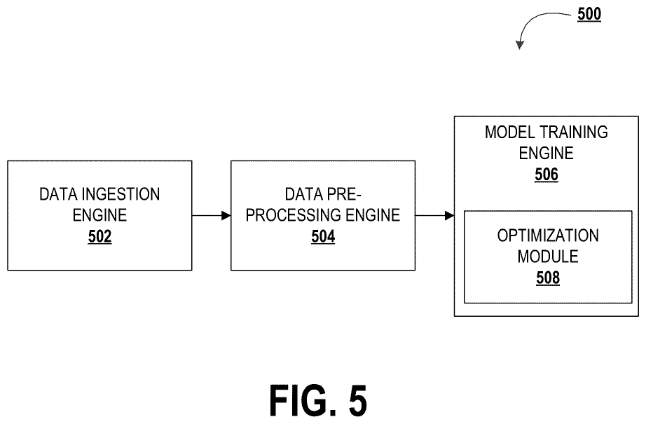

FIG. 5 illustrates an exemplary generative AI subsystem 500 associated with the predictive artificial intelligence engine 370 of the electronic communication analysis and consolidation system 300, in accordance with an embodiment of the invention. The generative AI subsystem 500 may include a data ingestion engine 502, a data pre-processing engine 504, and a model training engine 506. It should be understood that the generative AI subsystem 500 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 500 should not be considered limiting and may be adapted to various configurations within the scope of the invention.

The data ingestion engine 502 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 502 may support decentralized storage systems, such as blockchain-based data sources, and privacy-preserving methods such as differential privacy. The data ingestion engine 502 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 502 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 500 may utilize one or more machine learning techniques to generate new content. In machine learning, the quality of data and the useful information that may be derived therefrom directly affects the ability of the machine learning model to learn. The data pre-processing engine 504 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 504 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 504 may transform categorical data into numerical formats that may be suitable for machine learning algorithms. In this regard, the data pre-processing engine 504 may use techniques such as one-hot encoding or label encoding depending on the nature of the categorical variables and the intended use of the data.

In some embodiments, the data pre-processing engine 504 may also include dimensionality reduction techniques, where the number of input features is reduced while retaining the most relevant information. In this regard, the data pre-processing engine 504 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 504 may then be fed into the model training engine 506.

The model training engine 506 may be responsible for training the generative AI models using the pre-processed data from the data pre-processing engine 504. The model training engine 506 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 506 may optimize these models by continuously adjusting their internal parameters based on the patterns and relationships identified within the data.

In some embodiments, the model training engine 506 may include a training data handler, which manages the partitioning of the pre-processed data into training, validation, and testing datasets. The training data may be used to update the model's parameters, while the validation and testing datasets may be reserved to evaluate the model's performance during and after training. The model training engine 506 may support various data-handling strategies, such as cross-validation or random shuffling, to ensure that the model generalizes well and is not overfitting to the training data.

In embodiments involving large language models, the model training engine 506 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 506 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 506 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 506 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 506, which includes an optimization module 508, may implement various optimization techniques to improve model performance and efficiency. The optimization module 508 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 508 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 506 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 506 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 506 may synchronize the updates across the nodes using techniques like synchronous or asynchronous gradient descent.

Once the generative AI model is trained, the model training engine 506 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 506 may also implement transfer learning, where a pre-trained model is fine-tuned on a smaller, domain-specific dataset. This may reduce the amount of time and data required to train a new model, especially in cases where the available data is limited or highly specialized. The model training engine 506 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 500 illustrated in FIG. 5 is exemplary and that other embodiments may vary. The generative AI subsystem 500, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

It will be understood that the embodiment of the generative AI subsystem 500 illustrated in FIG. 5 is exemplary and that other embodiments may vary. The generative AI subsystem 500, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

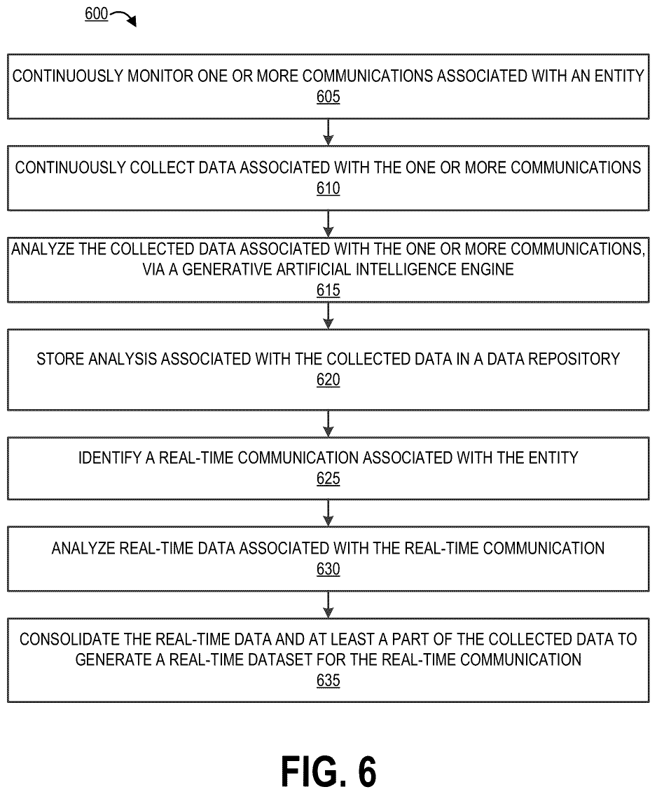

FIG. 6 provides a process flow for automatically analyzing and consolidating real-time and historical communications received through separate transmissions in a remote electronic environment, in accordance with an embodiment of the invention. As shown in block 605, the system continuously monitors one or more communications associated with an entity. In some embodiments, the one or more communications may be between at least one of plurality of users, a plurality of user devices, a plurality of entity systems, and a plurality of other entity systems. For example, two employees associated with the entity may communicate via an audio or video conferencing channel or text communication channel and the system monitors are captures the communication. In some embodiments, the one or more communications are physical live conversations between users associated with the entity captured by an entity system associated with the entity. In some embodiments, the one or more communications are transmitted over a plurality of separate transmissions.

As shown in block 610, the system continuously collects data associated with the one or more communications. In some embodiments, collecting the data associated with the one or more communications further comprises at least one of transforming the collected data, rearranging the collected data, and storing the collected data in a data format that is compatible with a generative artificial intelligence engine. In some embodiments, the system may utilize language learning models to perform one or more steps described herein. In one example, the system may determine that two users discussed about a topic ‘X’ in four instances during a first communication, the system may rearrange and group information (transcript, data, and/or the like) associated with the four instances. In some embodiments, transforming the collected data, rearranging the collected data, and/or storing the collected data in the data format that is compatible with the generative artificial intelligence engine optimizes and improves efficiency of the data analysis process performed by the generative artificial intelligence engine.

As shown in block 615, the system analyzes the collected data associated with the one or more communications, via the generative artificial intelligence engine. In some embodiments, analyzing the collected data comprises identifying data points associated with the one or more communications, where the data points could be useful to associate the one or more communications with one or more future communications. As shown in block 620, the system stores analysis associated with the collected data in a data repository.

As shown in block 625, the system identifies a real-time communication associated with the entity. The system may identify the real-time communication based on continuously monitoring communications associated with the entity. In some embodiments, the real-time communication may be between at least one of plurality of users, a plurality of user devices, a plurality of entity systems, and a plurality of other entity systems. In some embodiments, the real-time communication may be physical live conversation between users associated with the entity captured by an entity system associated with the entity. In some embodiments, the real-time communication is transmitted over a separate transmission different from the transmissions associated with the one or more communications.

As shown in block 630, the system analyzes real-time data associated with the real-time communication. In some embodiments, analyzing the real-time data further comprises parsing through the analysis associated with collected data stored in the data repository to identify at least a part of the collected data that is associated with the real-time data. Parsing through the analysis associated with the collected data comprises parsing through the data points associated with the one or more communications generated by the generative artificial intelligence engine in block 615.

As shown in block 635, the system consolidates the real-time data and at least a part of the collected data to generate a real-time dataset for the real-time communication. The real-time dataset may aid in enhancing and enriching the real-time communication by the entity systems, users, user devices, and/or the like involved in the real-time communication. In some embodiments, the system may provide the real-time dataset while the real-time communication is ongoing. In some embodiments, the real-time dataset may comprise summary of historical communications associated with the same topic as that of the real-time communication and also present additional information (e.g., insights, reminders, and/or the like) instantaneously upon initiation of the real-time communication. For example, the system may present a summary of previous discussions associated with the same topic that is being discussed in the real-time communication and also present potential talking points to discuss during the real-time communication which the users may have decided to talk about in future discussions during historical communications. In some embodiments, the system generates one or more summaries or one or more reports associated with the one or more communications and the real-time communication and present the one or more summaries or the one or more reports to one or more users associated with the entity. In some embodiments, the system may present the summaries, the reports, and/or the real-time dataset via a channel (e.g., audio channel, video channel, text channel, web interface, entity application, and/or the like) which was used to initiate the real-time communication.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein. CLAIMS:

1. A system for automatically analyzing and consolidating real-time and historical communications received through separate transmissions in a remote electronic environment, the system comprising:
at least one network communication interface;
at least one non-transitory storage device; and
at least one processing device coupled to the at least one non-transitory storage device and the at least one network communication interface, wherein the at least one processing device is configured to:
continuously monitor one or more communications associated with an entity;
continuously collect data associated with the one or more communications;
analyze the collected data associated with the one or more communications, via a generative artificial intelligence engine;
store analysis associated with the collected data in a data repository;
identify a real-time communication associated with the entity;
analyze real-time data associated with the real-time communication; and
consolidate the real-time data and at least a part of the collected data to generate a real-time dataset for the real-time communication.

2. The system of claim 1, wherein analyzing the real-time data further comprises parsing through the analysis associated with collected data stored in the data repository to identify at least the part of the collected data that is associated with the real-time data.

3. The system of claim 1, wherein continuously collecting the data associated with the one or more communications further comprises at least one of:
transforming the collected data;
rearranging the collected data; and
storing the collected data in a data format that is compatible with the generative artificial intelligence engine.

4. The system of claim 1, wherein the at least one processing device is configured to generate one or more summaries or one or more reports associated with the one or more communications and the real-time communication.

5. The system of claim 1, wherein the one or more communications and the real-time communication are transmitted over a plurality of separate transmissions.

6. The system of claim 1, wherein the one or more communications and the real-time communication are physical live conversations between users associated with the entity captured by an entity system associated with the entity.

7. The system of claim 1, wherein the one or more communications and the real-time communication are between at least one of plurality of users, a plurality of user devices, a plurality of entity systems, and a plurality of other entity systems.

8. A computer program product for automatically analyzing and consolidating real-time and historical communications received through separate transmissions in a remote electronic environment, the computer program product comprising a non-transitory computer-readable storage medium having computer executable instructions for causing a computer processor to perform the steps of:
continuously monitoring one or more communications associated with an entity;
continuously collecting data associated with the one or more communications;
analyzing the collected data associated with the one or more communications, via a generative artificial intelligence engine;
storing analysis associated with the collected data in a data repository;
identifying a real-time communication associated with the entity;
analyzing real-time data associated with the real-time communication; and
consolidating the real-time data and at least a part of the collected data to generate a real-time dataset for the real-time communication.

9. The computer program product of claim 8, wherein analyzing the real-time data further comprises parsing through the analysis associated with collected data stored in the data repository to identify at least the part of the collected data that is associated with the real-time data.

10. The computer program product of claim 8, wherein continuously collecting the data associated with the one or more communications further comprises at least one of:
transforming the collected data;
rearranging the collected data; and
storing the collected data in a data format that is compatible with the generative artificial intelligence engine.

11. The computer program product of claim 8, wherein the computer executable instructions cause the computer processor to perform the step of generating one or more summaries or one or more reports associated with the one or more communications and the real-time communication.

12. The computer program product of claim 8, wherein the one or more communications and the real-time communication are transmitted over a plurality of separate transmissions.

13. The computer program product of claim 8, wherein the one or more communications and the real-time communication are physical live conversations between users associated with the entity captured by an entity system associated with the entity.

14. The computer program product of claim 8, wherein the one or more communications and the real-time communication are between at least one of plurality of users, a plurality of user devices, a plurality of entity systems, and a plurality of other entity systems.

15. A computer implemented method for automatically analyzing and consolidating real-time and historical communications received through separate transmissions in a remote electronic environment, wherein the method comprises:
continuously monitoring one or more communications associated with an entity;
continuously collecting data associated with the one or more communications;
analyzing the collected data associated with the one or more communications, via a generative artificial intelligence engine;
storing analysis associated with the collected data in a data repository;
identifying a real-time communication associated with the entity;
analyzing real-time data associated with the real-time communication; and
consolidating the real-time data and at least a part of the collected data to generate a real-time dataset for the real-time communication.

16. The computer implemented method of claim 15, wherein analyzing the real-time data further comprises parsing through the analysis associated with collected data stored in the data repository to identify at least the part of the collected data that is associated with the real-time data.

17. The computer implemented method of claim 15, wherein continuously collecting the data associated with the one or more communications further comprises at least one of:
transforming the collected data;
rearranging the collected data; and
storing the collected data in a data format that is compatible with the generative artificial intelligence engine.

18. The computer implemented method of claim 15, wherein the method comprises generating one or more summaries or one or more reports associated with the one or more communications and the real-time communication.

19. The computer implemented method of claim 15, wherein the one or more communications and the real-time communication are transmitted over a plurality of separate transmissions.

20. The computer implemented method of claim 15, wherein the one or more communications and the real-time communication are between at least one of plurality of users, a plurality of user devices, a plurality of entity systems, and a plurality of other entity systems.
